(19) United States
(12) Patent Application Publication
(10) Pub. No.: US 2026/0250192 A1
(43) Pub. Date: Aug. 27, 2026

(54) LUMINESCENT AGGLOMERATED STONE MATERIAL, MANUFACTURING METHOD AND APPLICATIONS THEREOF

(71) Applicant: HENDRIX INDUSTRIES, Sealy, TX (US)

(72) Inventors: Eladio Piñero Gonzalez, Sealy, TX (US); Jacob Lee Polmanteer, Sealy, TX (US); James Ronald Duke, JR., Sealy, TX (US)

(21) Appl. No.: 19/541,107

(22) Filed: Feb. 16, 2026

Related U.S. Application Data
(60) Provisional application No. 63/762,855, filed on Feb. 25, 2025.

(51) Int. Cl. C04B 14/22; C04B 14/28; C04B 14/30

(52) U.S. Cl. CPC C04B 14/22; C04B 14/28; C04B 14/303

(57) ABSTRACT

The present disclosure relates to an agglomerated stone material exhibiting a luminescent effect under UV illumination. The composition comprises aggregates, fillers, a polymeric binder, and at least one luminescent agent, which is present in an amount ranging from 0.001% to 15% w/w, selected from optical brighteners, fluorescent pigments, or phosphorescent pigments. The disclosure also provides a manufacturing method, which includes mixing the aggregates, adding the polymeric binder, incorporating fillers and luminescent agents, distributing the mixture into a mold, compacting it by vacuum vibrocompression, curing the material, and optionally applying finishing treatments, wherein the luminescent agent is incorporated in its pure form or predispersed in aggregates, pigments or the polymeric binder. Finally, the disclosure refers to the use of the agglomerated stone material in architectural or decorative surfaces, signage or information displays or safety markers and wayfinding systems.

### CROSS-REFERENCE TO RELATED APPLICATIONS

This application claims the benefit of priority to U.S. Provisional Application Ser. No. 63/762,855 filed Feb. 25, 2025, which is hereby incorporated by reference in its entirety.

### FIELD

The present disclosure relates to the field of engineered stone materials, specifically to agglomerated stone materials comprising one or more luminescent agents, such as optical brighteners, fluorescent pigments, and/or phosphorescent pigments. These luminescent agents provide unexpected aesthetic and functional enhancements in said agglomerated stone compositions, enabling light-responsive visual effects under different lighting conditions, including UV illumination.

### BACKGROUND

Agglomerated stone, also referred to as engineered stone or artificial stone, is a composite material designed to replicate the appearance and properties of natural stone while offering enhanced performance characteristics. These materials are widely used in construction and decoration industries due to their high durability, aesthetic versatility, and resistance to stains and wear, making them a popular alternative to quarried stone.

Agglomerated stone is typically composed of a mixture of natural and synthetic aggregates (such as quartz, feldspar, granite, and glass) bound together by a polymeric resin. Unlike natural stone, which is directly extracted from quarries, engineered stone is manufactured through an industrial process, allowing for greater control over its composition, texture, and color variations.

The manufacturing process of agglomerated stone generally involves mixing the selected aggregates with a polymeric binder, pigments, catalysts, and other additives, followed by compaction through vacuum vibrocompression, curing, and surface finishing. This controlled process ensures a highly durable, non-porous material with a customizable appearance, making it suitable for applications such as kitchen countertops, flooring, and wall claddings.

Aesthetic appeal plays a crucial role in the selection of engineered stone products, with manufacturers continuously seeking innovative ways to enhance their visual and functional properties. Traditional methods for modifying the appearance of agglomerated stone involve the use of colored pigments, metal flakes, and natural veining patterns to mimic real stone. However, these conventional methods produce static visual effects that do not respond to environmental conditions such as lighting variations.

For example, the appearance of agglomerated stone has been primarily based on conventional pigments and mineral particles, which create static visual effects. But the possibility of achieving dynamic visual effects under different lighting conditions without altering the material's appearance under normal lighting has not been explored.

Optical brighteners, fluorescent pigments, and phosphorescent pigments are known for their ability to interact with light in unique ways. Optical brighteners absorb UV light and re-emit it as visible blue light, enhancing the perceived brightness and whiteness of materials. Fluorescent pigments absorb short-wavelength light and instantly emit it as vivid colors, producing a striking visual effect. Phosphorescent pigments, on the other hand, store light energy and release it gradually over time, enabling a glow-in-the-dark effect.

Despite the known applications of luminescent materials in textiles, plastics, and coatings, their effective integration into agglomerated stone remains largely unexplored due to material compatibility challenges. The inherent challenges include ensuring compatibility between these luminescent agents and the polymeric binder, maintaining the mechanical strength of the final product, and achieving consistent dispersion of the additives within the composite matrix. In particular, luminescent agents, especially optical brighteners and fluorescent pigments, are traditionally used in aqueous media or polar solvents, which makes their dispersion in a hydrophobic polymeric resin challenging. Additionally, certain luminescent agents may degrade or lose their functionality when mixed with thermosetting resins. Furthermore, the addition of additives in a composite matrix can lead to cohesion issues, affecting critical properties such as hardness, impact resistance, and overall durability. If luminescent agents are not properly incorporated, they may act as weak points in the structure, increasing the likelihood of cracks or reduced resistance to mechanical loads. Moreover, agglomerated stone require a vacuum vibrocompression process, followed by thermal curing, which can degrade luminescent agents that are sensitive to high temperatures or prolonged exposure to free radicals during polymerization. In conventional processes, luminescent agents may decompose, lose their intensity, or even alter the reactivity of the resin. Additionally, poor dispersion of luminescent agents can result in uneven effects or uncontrolled accumulations, compromising both the appearance and functionality of the material. In traditional composite materials, achieving uniform dispersion of ultra-fine particles remains a significant technical challenge, particularly due to density differences between components.

### BRIEF DESCRIPTION OF THE DRAWINGS

FIG. 1: A sample of the bulk mass incorporating Fluorescent Brightener 184, observed under regular lighting conditions (left) and under UV light (right).

FIG. 2: A sample composed of multiple masses, incorporating Fluorescent Brightener 184, observed under regular lighting conditions (left) and under UV light (right).

FIG. 3: A sample incorporating scatter veins with Fluorescent Brightener 184 and Fluorescent Brightener 393, observed under regular lighting conditions (left) and under UV light (right).

FIG. 4: A sample incorporating thin veins with Fluorescent Brightener 184, observed under regular lighting conditions (left) and under UV light (right).

### DETAILED DESCRIPTION

Through a combination of appropriate luminescent agent selection, controlled dispersion, thermal stability, and process optimization, the present disclosure enables, for the first time, the effective integration of luminescent agents into agglomerated stone without compromising their mechanical, aesthetic, or functional properties. The selection of luminescent agents that are compatible with the polymeric matrix and resistant to the curing process, along with optimized concentration ranges, ensures that the luminescent functionality is maintained without significant degradation and without affecting the structural integrity of the agglomerate.

This novel approach enhances the visual appeal of the material under different lighting conditions, including UV illumination (commonly known as blacklight or Wood's lamp), while also providing improved whiteness perception in daylight conditions. By leveraging the light-interactive properties of these luminescent agents, the present disclosure introduces an unexpected and dynamic aesthetic dimension to engineered stone, expanding its decorative and functional applications.

In a first aspect, the disclosure refers to an agglomerated stone material that exhibits a luminescent effect under UV illumination, wherein the composition of said agglomerated stone material comprises:
a mixture of natural and/or synthetic aggregates and fillers,
a polymeric binder,
at least one luminescent agent, and
optionally, pigments,
   wherein the at least one luminescent agent is present in an amount ranging from 0.001% to 15% w/w.

The luminescent effect of the material is visible under UV light in the range of 300-400 nm, emitting visible light in the range of 400-700 nm.

The mixture of natural and/or synthetic aggregates and fillers constitute approximately 75-90% of the total weight of the material. Aggregates are in the form of granules and powder. The size of the particles can vary which allows for different textures and appearances in the final product.

Fillers are inert particulate materials incorporated into the composition to modify or enhance specific properties of the agglomerated stone material. These fillers can improve mechanical strength, reduce shrinkage, modify texture, enhance processability, or adjust the final appearance of the material. Common fillers include quartz, silica, alumina, and other mineral or synthetic compounds.

The polymeric binder represents about 6-15% of the total weight. The polymeric binder can be an unsaturated polyester resin, which acts as a binder to hold the aggregates together. Epoxy resins can also be used for specific applications requiring higher chemical resistance.

Catalysts (e.g. peroxides) can be also added as catalysts to initiate the polymerization process of the resin. Also, accelerators (e.g. cobalt) are used to speed up the curing process, ensuring that the resin hardens at a given temperature within a controlled timeframe. Adhesion promoters (e.g. silanes) can be added to ensure a cohesive bond between the aggregates and the polymeric resin.

In the present disclosure, luminescent agents are selected from the group consisting of optical brighteners, fluorescent pigments, phosphorescent pigments, and combinations thereof.

Optical brighteners, also known as optical brightening agents (OBAs) or fluorescent whitening agents (FWAs), are chemical compounds used to enhance the appearance of color and brightness in various materials. They achieve this by absorbing light in the UV and violet regions of the electromagnetic spectrum (typically between 340-370 nm) and re-emitting it as visible blue light (usually between 420-470 nm) through fluorescence.

Optical brighteners absorb UV light in the range of approximately 340-370 nm. After absorbing UV light, these compounds re-emit the absorbed energy as visible blue light in the range of 420-470 nm. This emitted blue light compensates for any yellowish tinge in the material, making it appear whiter and brighter to the human eye.

Although the pursuant effect is having materials that show different aesthetics when it is used under an UV illuminant (Absorption Range: 340-370 nm (UV light) and Emission Range: 420-470 nm (visible blue light); commonly known as blacklight, UV-A light or Wood's lamp), other desirable effect is its inherent property as optical brightener, making white products be perceived by the human eye as whiter.

In particular embodiments, optical brighteners can be selected from:
Stilbene Derivatives: These are the most common optical brighteners used in detergents and textiles. Examples include Tinopal CBS and Uvitex OB.
Coumarin Derivatives: Often used in cosmetics and personal care products. An example is 4-Methyl-7-diethylaminocoumarin.
Benzoxazole Derivatives: Used in plastics and synthetic fibers. Examples include 2,5-Bis(5-tert-butyl-2-benzoxazolyl)thiophene.
Pyrazoline Derivatives: These are used in paper and coatings. An example is 1,3-Diphenyl-2-pyrazoline.

In the present disclosure, the polymeric materials can be based in 2,5-Bis(5-tert-butyl-2-benzoxazolyl)thiophene including:
Fluorescent brightener 184-Benzoxazole, 2,2′-(2,5-thiophenediyl)bis(5-(1,1-dimethylethyl)-2,2′-(2,5-thiophenediyl)-bis(5-tert-butylbezoxazole),
Fluorescent brightener 393-Benzoxazole, 2,2′-(1,2-ethenediyldi-4,1-phenylene)bis-2,2′-(vinylenedi-4-phenylene)bis(benzoxazole)

From these two, the fluorescent brightener 184 can provide an emission color that is more neutral.

Fluorescent pigments are special types of colorants that can absorb light at specific wavelengths and re-emit it at longer wavelengths, resulting in bright and vivid colors. These pigments are widely used in various applications due to their ability to produce eye-catching and brilliant colors.

Fluorescent pigments absorb light in the UV or blue region of the electromagnetic spectrum. After absorbing the light, the pigments re-emit it as visible light at longer wavelengths. This process is known as fluorescence. The emitted light is typically in the visible spectrum, making the colors appear more vibrant and intense.

In particular embodiments, fluorescent pigments can be selected from:
Rhodamine B: A common fluorescent dye used in various applications, including textiles and inks. It emits bright pink or red fluorescence.
Fluorescein: Often used in medical diagnostics and as a tracer dye. It emits green fluorescence.
Auramine O: Used in biological staining and as a dye for textiles. It emits yellow fluorescence.
Coumarin: Used in laser dyes and as a fluorescent brightener. It emits blue fluorescence.

Fluorescent pigments typically absorb light in the UV to blue region, around 300-400 nm. The re-emitted light is usually in the visible spectrum, ranging from 400-700 nm, depending on the specific pigment.

Fluorescent pigments are valued for their ability to produce colors that are much brighter and more vivid than those achieved with conventional pigments. This makes them ideal for applications where high visibility and aesthetic appeal are important.

Phosphorescent pigments are special types of colorants that can absorb light energy and re-emit it over an extended period, resulting in a “glow-in-the-dark” effect. Unlike fluorescent pigments, which emit light almost immediately after absorbing it, phosphorescent pigments release the absorbed energy slowly, allowing them to glow for minutes to hours after the light source is removed.

Phosphorescent pigments absorb light, typically in the UV or blue region of the electromagnetic spectrum. The absorbed light energy excites electrons to a higher energy state. In phosphorescent materials, these electrons become trapped in a metastable state.

Slow emission of light occurs as the trapped electrons gradually return to their ground state, releasing the stored energy as visible light. This process can continue for a prolonged period, resulting in a persistent afterglow.

In particular embodiments, phosphorescent pigments can be selected from:
Zinc Sulfide: One of the earliest and most common phosphorescent materials, often doped with copper to enhance its glow. It emits a greenish glow.
Strontium Aluminate: A newer and more efficient phosphorescent material that provides a brighter and longer-lasting glow compared to zinc sulfide. It can emit light in various colors, including green and blue.
Europium-Doped Strontium Aluminate: This compound is known for its high brightness and long afterglow duration, making it ideal for high-performance applications.

Phosphorescent pigments typically absorb light in the UV to blue region, around 300-400 nm. The re-emitted light is usually in the visible spectrum, ranging from 450-700 nm, depending on the specific pigment.

Phosphorescent pigments are valued for their ability to provide long-lasting luminescence, making them useful in a wide range of practical and decorative applications.

In particular embodiments, pigments can be optionally incorporated into the composition of the agglomerated stone to provide color and enhance the material's properties. Pigments can be natural or synthetic and are used to achieve a wide range of colors and patterns.

Other additives such as UV stabilizers, antimicrobial agents, and impact modifiers can be included to improve the durability and functionality of the stone agglomerate.

The at least one luminescent agent can be present in an amount ranging from 0.001% to 15% w/w, depending on the desired effect and the structural configuration of the agglomerated stone material, or, in some aspects, from 0.01% to 5% w/w.

The agglomerated stone material of the present disclosure can be formed as a bulk mass or as multiple masses, wherein, in the case of multiple masses, the at least one luminescent agent is present in at least one of said masses. In both cases, the at least one luminescent agent can be incorporated in an amount from 0.001% to 15% w/w or, in some aspects, from 0.01% to 5% w/w.

In a particular embodiment, the agglomerated stone material further comprises at least one embellishment (decorative feature), wherein the at least one luminescent agent is incorporated into said at least one embellishment. In that case, the at least one luminescent agent can be present in an amount from 0.001% to 15% w/w or, in some aspects, from 0.01% to 5 % w/w.

These embellishments or decorative features can include:
Scatter veins, thin veins, or thick veins, which create defined luminous patterns under ultraviolet light.
Interfaces, which separate two masses and generate a distinct color transition between them. These interfaces may be formed using pigments or luminescent agents, creating visible or UV-reactive patterns at the boundary of the masses.

In some aspects, the present disclosure includes a method for manufacturing the agglomerated stone material of the present disclosure comprising the following steps:
a) mixing natural and/or synthetic aggregates with pigments, if present;
b) adding the polymeric binder to the mixture obtained in a) and mixing;
c) incorporating the fillers to the mixture obtained in b) and mixing;
d) distributing the obtained mixture into a mold,
e) compacting the mixture using vacuum vibrocompression;
f) curing the compacted material to form the agglomerated stone material; and
g) optionally finishing the material by cutting, polishing, or other surface treatments,
   wherein at least one luminescent agent is incorporated i) in its pure form or predispersed in the aggregates or optional pigments in step a), ii) predispersed in the polymeric binder in step b), or (iii) in its pure form or predispersed in the polymeric binder, aggregates, or pigments after step c) and before step e).

The at least one luminescent agent is selected from the group consisting of optical brighteners, fluorescent pigments, phosphorescent pigments, and combinations thereof.

The incorporation method depends on the type of luminescent agent used, its compatibility with the matrix, and the desired luminescent effect. This flexibility allows for better control over the dispersion, intensity, and uniformity of the luminescent effect in the final product.

The method of the disclosure involves a sequence of steps that ensure the proper distribution and integration of the components, including the luminescent agent, while maintaining the desired mechanical and aesthetic properties of the final product.

Initially, in step a), natural and/or synthetic aggregates are mixed together. If pigments are included in the formulation, they are incorporated at this stage to ensure even dispersion throughout the aggregates. This step ensures that the color is well distributed before the addition of the polymeric binder.

Once the aggregates (and pigments, if present) are mixed, the polymeric binder is added (step b). This binder acts as the matrix that holds the aggregates together once cured. Along with the binder, several functional additives may also be incorporated in this step, including: catalysts and accelerators, that facilitate polymerization and curing; adhesion promoters (e.g., silanes), that improves bonding between the binder and the aggregates; stabilizers (e.g., UV stabilizers), that enhance durability and resistance to environmental factors, etc.

Following the polymeric binder addition, fillers are introduced into the mixture in step c). These fillers help to enhance specific properties such as mechanical strength, processability, and final texture. The mixture is mixed again to achieve a homogeneous composition.

As mentioned above, the at least one luminescent agent can be included in step a), b) or in its pure form or predispersed in the polymeric binder, aggregates, or pigments after step c) and before step e).

Once the components are fully mixed, the resulting composition is distributed into a mold (step d), where it takes the desired shape and structure. At this stage, the agglomerated stone material can be configured in one of two ways:
Bulk mass: The mixture is distributed homogeneously throughout the mold, ensuring that all components, including the luminescent agent, are evenly spread.
Multiple masses: The composition is divided into separate portions, allowing for different formulations within the same product. In this case, the luminescent agent is incorporated in at least one of the masses, which may result in a non-uniform distribution of the luminescent effect across the final product.

In both cases, the at least one luminescent agent can be incorporated in an amount ranging from 0.001% to 15% w/w or, in some aspects, from 0.01% to 5%.

This step defines the structural arrangement of the material and ensures proper placement of the luminescent agent before the compaction process.

In step e), the distributed mixture undergoes vacuum vibrocompression, a process that removes air and compacts the material, ensuring high density and minimal porosity. This step enhances the mechanical properties of the final product, improving its durability, strength, and surface quality of the final product.

The compacted material is then subjected to a curing process (step f), which involves heating at a controlled temperature and time to complete the polymerization of the binder. This step solidifies the structure and ensures that the luminescent agent remains effectively integrated into the material.

Once cured, the agglomerated stone material can undergo finishing treatments (step g), including:
Cutting to achieve the desired dimensions.
Polishing to enhance surface smoothness and shine.
Other surface treatments to improve durability, resistance to stains, scratches, or aesthetic appeal.

These finishing steps allow the material to meet specific design and performance requirements, making it suitable for applications such as countertops, flooring, wall cladding, and decorative elements.

In a particular embodiment, in addition to being integrated within the bulk or multiple masses, the luminescent agent can also be incorporated into embellishments that enhance the visual appearance of the material.

Embellishments such as scatter veins, thin veins, thick veins or interfaces can be incorporated in step c) or d). The at least one luminescent agent may be:
Added into said at least embellishment in pure concentration, ensuring maximum luminescent intensity, or
Dispersed together with pigments, aggregates and/or or polymer binder, allowing for more controlled and uniform distribution within the embellishment.

The amount of luminescent agent in embellishments typically ranges from 0.001% to 15% w/w or, in some aspects, from 0.01% to 5% w/w, depending on the desired visual effect.

In particular, interface may be incorporated into the material to create a defined color pattern between two masses. An interface consists of at least one type of pigment and/or luminescent agent, positioned between two distinct masses. Traditionally, interfaces are formed using pigments or pre-dispersed pigment formulations. However, in the present disclosure, luminescent agents can also be used to generate luminous interface effects under ultraviolet light.

Interfaces are placed when the mixture is distributed into the mold (step d), ensuring that the luminescent agent is positioned at the boundary between two different masses before compaction.

The agglomerated stone material of the present disclosure exhibits a luminescent effect under ultraviolet (UV) illumination (blacklight or Wood's lamp), while also providing improved whiteness perception in daylight conditions, making it suitable for various aesthetic and functional applications. This effect enhances the visual appeal and usability of the material in different environments, particularly in low-light conditions or where a distinctive luminous appearance is desired. The material can be applied in multiple industries, including architecture, interior design, signage, and safety systems. Some particular applications include:
Countertops and work surfaces: The luminescent effect can provide decorative accents in kitchens, bathrooms, and commercial spaces, adding a unique visual characteristic under UV lighting.
Flooring: Used in residential, commercial, or public spaces, the luminescent properties can enhance aesthetics or serve as a guidance system in low-light environments.
Wall cladding and decorative panels: The material can be installed on walls to create striking visual effects when exposed to UV light, making it ideal for hotels, retail spaces, or entertainment venues.
Signage and information displays: The luminescent properties of the material can be utilized to create illuminated signs, decorative lettering, or artistic engravings, improving visibility in dimly lit areas.
Safety markers and wayfinding: The material can be used for emergency exit markers, pathway indicators, or hazard warnings, enhancing visibility in public buildings, transportation hubs, and outdoor spaces.

By integrating luminescent agents into the composition, the present disclosure provides a durable and visually dynamic material that expands the range of applications for engineered stone, offering both functional benefits and aesthetic enhancements.

The following examples illustrate the present disclosure:

### EXAMPLES

### Example 1. Addition of Fluorescent Brightener 184 to the Bulk Mass

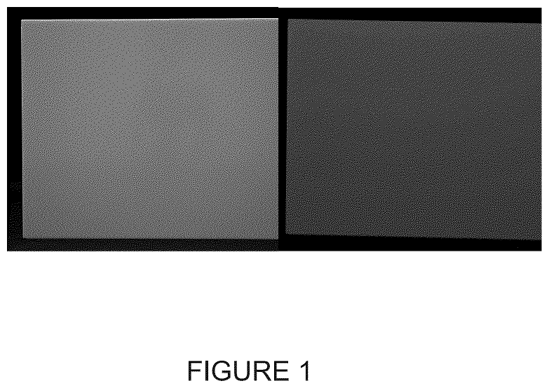

In order to incorporate the luminescent agent to the bulk mass, the luminescent agent was predispersed in the polymeric resin (1% R) (the concentration of the luminescent agent in the final composition will range approximately between 0.06% and 0.15% w/w). The addition of these pigments was evenly integrated during the mixing process. As a result, the whole body of material showed the desired effect. In FIG. 1(left) the sample of the bulk mass incorporating Fluorescent Brightener 184, observed under regular lighting conditions is shown. The material appears with its regular appearance, indicating that the brightener does not significantly alter its visible color in daylight. In FIG. 1(right) the same sample is observed under UV light. The presence of Fluorescent Brightener 184 causes the material to emit a bright blue hue, demonstrating its fluorescence when exposed to UV radiation.

### Example 2. Addition of Fluorescent Brightener 184 to at Least One Mass for Products That Comprise Multiple Masses

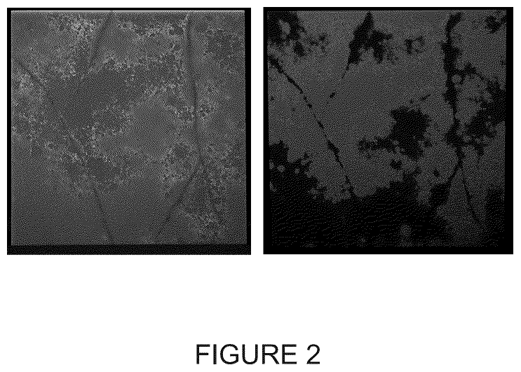

The luminescent agent was added at least to one of the multiple masses that comprise a multicolor or a multilayered product, the agent was predispersed in the polymeric resin (1% R). The addition of these pigments was evenly integrated during the mixing process. As a result, some parts of the resulting product showed areas with different intensities of the wanted effect. In FIG. 2 (left) the sample composed of multiple masses, incorporating Fluorescent Brightener 184, observed under regular lighting conditions is shown. The material appears with its regular appearance with areas with different intensities, indicating the presence of distinct regions within the composite structure. The luminescent agent does not significantly alter the material's appearance under visible light. In FIG. 2 (right), the same sample is observed under UV light. The background emits a bright blue hue due to the fluorescence of Brightener 184, while irregular diffuse patches appear darker, creating a contrast between luminescent and non-luminescent regions characteristic of a multiple-mass configuration.

### Example 3: Addition of Luminescent Agent/s as Embellishments: Such as Scatter Veins, Thin Veins and/or Thick Veins

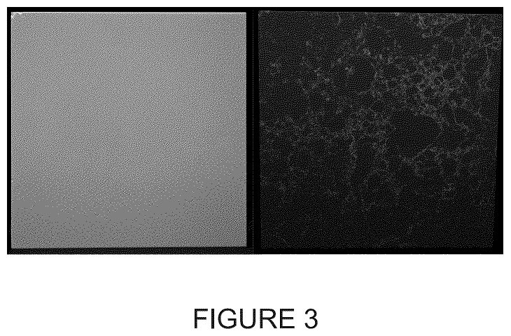

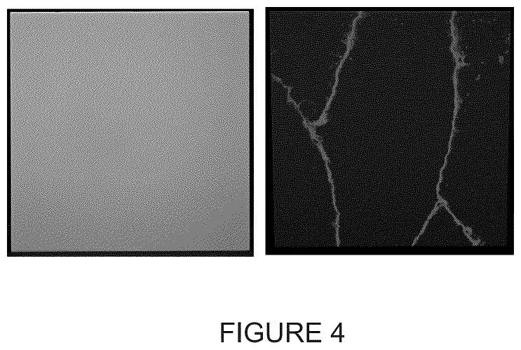

Once the mixture was produced, at least one embellishment, containing the luminescent agent, was added. In order to incorporate the agent, and depending on the type of embellishment, was dispersed together with the aggregates preparations to facilitate the desired effect (the agent was added to liquid or solid preparations) at 5%. In FIG. 3 (left) the sample incorporating scatter veins with Fluorescent Brightener 184 and Fluorescent Brightener 393, observed under regular lighting conditions is shown. The material appears as a uniform regular appearance, with no visible differentiation in the scatter vein regions, indicating that the luminescent embellishments remain visually indistinguishable under normal light. In FIG. 3 (right) the same sample is observed under UV light. The luminescent embellishments become highly visible, with a dark blue-black background highlighting scattered veins that fluoresce in green and bright blue hues due to the presence of Brightener 184 and Brightener 393. This effect demonstrates the ability to create dynamic, light-sensitive patterns that emerge under specific illumination. In FIG. 4 (left) the sample incorporating thin veins with Fluorescent Brightener 184, is observed under regular lighting conditions. The material appears as a uniform regular appearance, with the veins remaining invisible to the naked eye under normal light. In FIG. 4 (right) the same sample is observed under UV light. The previously invisible veins are now revealed as two bright blue, branching lines against a dark blue-black background. This effect highlights the ability to create hidden patterns or markings that only appear under specific lighting conditions.

1. An agglomerated stone material, wherein the composition of said agglomerated stone material comprises:
a mixture of natural and/or synthetic aggregates and fillers,
a polymeric binder,
at least one luminescent agent selected from the group consisting of optical brighteners, fluorescent pigments, phosphorescent pigments, and combinations thereof, and
optionally, pigments,
wherein the at least one luminescent agent is present in an amount ranging from 0.001% to 15% w/w, and
wherein the material exhibits a luminescent effect under UV illumination.

2. The agglomerated stone material according to claim 1, wherein the luminescent effect of the material is visible under UV light in the range of 300-400 nm, emitting visible light in the range of 400-700 nm.

3. The agglomerated stone material according to claim 1, wherein the at least one luminescent agent is an optical brightener.

4. The agglomerated stone material according to claim 3, wherein the optical brightener is at least one benzoxazole derivative.

5. The agglomerated stone material according to claim 1, wherein the material comprises:
a bulk mass, or
multiple masses, wherein the at least one luminescent agent is present in at least one of said masses.

6. The agglomerated stone material according to claim 1, further comprising at least one embellishment, wherein the at least one luminescent agent is incorporated into said at least one embellishment.

7. The agglomerated stone material according to claim 1, wherein the at least one luminescent agent is present in an amount ranging from 0.01% to 5% w/w.

8. A method for manufacturing an agglomerated stone material according to
claim 1, wherein the method comprises the following steps:
a) mixing natural and/or synthetic aggregates and optionally with pigments;
b) adding the polymeric binder to the mixture obtained in a) and mixing;
c) incorporating the fillers to the mixture obtained in b) and mixing;
d) distributing the mixture obtained in c) into a mold,
e) compacting the mixture using vacuum vibrocompression;
f) curing the compacted material to form the agglomerated stone material; and
g) optionally finishing the cured material by cutting, polishing, or other surface treatments,
wherein the at least one luminescent agent is incorporated, in an amount ranging from 0.001% to 15% w/w, either:
i) in its pure form or predispersed in the aggregates or pigments in step a),
ii) predispersed in the polymeric binder in step b), or
iii) in its pure form or predispersed in the polymeric binder, aggregates, or pigments after step c) and before step e), and
wherein the at least one luminescent agent is selected from the group consisting of optical brighteners, fluorescent pigments, phosphorescent pigments, and combinations thereof.

9. The method according to claim 8, wherein the agglomerated stone material is formed as:
a bulk mass, or
multiple masses, wherein the at least one luminescent agent is incorporated in at least one of said masses.

10. The method according to claim 8, wherein the luminescent agent is incorporated in the material in an amount ranging from 0.01% to 5% w/w.

11. The method according to claim 8, wherein at least one embellishment is incorporated in step c) or d), being the at least one luminescent agent incorporated into said at least one embellishment in a pure concentration or dispersed together with pigments, aggregates and/or polymer binder.

12. The method according to claim 11, wherein at least one interface is incorporated during step d), the interface comprising at least one luminescent agent positioned between the boundary of two masses defining a color pattern.

13. An architectural and/or decorative surface, signage and/or information display, or safety marker and/or wayfinding system, comprising the agglomerated stone material according to claim 1.
